(19) United States
(12) Patent Application Publication
(10) Pub. No.: US 2011/0018448 A1
(43) Pub. Date: Jan. 27, 2011

(54) SYSTEM AND METHOD FOR AN OUTDOOR LIGHTING FEATURE WITH AN INTEGRATED SOLAR PANEL

(76) Inventors: Charles R. Metchear, III, Naples, FL (US); Elizabeth K. Piper, Naples, FL (US)

Correspondence Address: LANDO & ANASTASI, LLP, ONE MAIN STREET, SUITE 1100, CAMBRIDGE, MA, 02142, US

(21) Appl. No.: 12/508,283

(22) Filed: Jul. 23, 2009

(51) Int. Cl. H05B 37/02; F21L 4/00

(52) U.S. Cl. 315/152; 362/183; 315/294

(57) ABSTRACT

A system and method for operating an outdoor lighting feature is provided, the outdoor lighting feature including a bollard, a solar panel disposed within a recess on the top of the bollard, a battery disposed within the bollard, the battery being electrically coupled to the solar panel and configured to receive and store energy from the solar panel, and a light source oriented to direct a light beam to a region external to the bollard, the light source being configured to draw an electric load from the battery. The system detects a change in an ambient light level, starts a timer and places a light source in a high-on state in response to the change in the ambient light level, monitors the timer, places the light source in a low-on state upon measuring a first predefined amount of lapsed time on the timer, and places the light source in an off state upon measuring a second predefined amount of lapsed time on the timer.

### BACKGROUND

1. Field of the Invention

The present invention relates generally to outdoor lighting features, and more specifically, to lighting features powered by solar energy.

2. Discussion of Related Art

Outdoor lighting is often desirable during nighttime hours for purposes of security, aesthetics, and avoiding injuries associated with walking on unlit terrain. Light sources may be provided in a variety of housings as dictated by location and aesthetics. As one example, pathway lights may be used to illuminate the ground near the light source in order to increase the visibility of a walkway or other outdoor area.

To reduce the energy costs and labor associated with electrically coupling outdoor lighting to a domestic power supply, some outdoor lighting sources have been provided with solar panels or other mechanisms for generating energy without requiring a connection to the domestic power supply, as well as one or more batteries to store the power generated by the solar panels in order that the light source can be powered in the darkness. However, most of these solar panels are located remotely from the housing of the lighting source itself. For example, the solar panels and batteries may be attached at the top of a separate pole. For these reasons, small lighting sources known in the art have been limited in the size of the solar panels and batteries they utilize. This limitation has in turn constrained the amount of energy that can be captured and stored for later use by the lighting source. Thus, lighting sources known in the art often have an intensity and operating time that is insufficient for many outdoor lighting applications.

### SUMMARY

Embodiments of the present invention solve the problems of the solar-powered lighting features known in the art by providing a bollard that integrates the solar panel into one or more of its surfaces. This allows for a much larger solar panel to be used, which in turn increases the intensity and duration of light that can be generated through the light source. Embodiments of the present invention further address problems in the art by retaining the battery and other system components inside the bollard. By integrating those components, these embodiments allow for a larger, more efficient battery to be incorporated, which in turn increases the intensity and duration of light that can be generated through the light source. Some embodiments of the present invention further incorporate a charge controller and a timing device to increase the efficiency of the system by controlling factors that affect the battery life.

Embodiments of the present invention further improve over the prior art by incorporating light emitting diodes (LEDs) in the light source. LEDs are known in the art and are typically formed of a semiconductor diode. When an electric current passes through the diode, electrons are excited and release their energy as light. LEDs can be provided in a variety of colors. LEDs may be provided with integrated optical components to shape their radiation pattern and assist in reflection. LEDs typically generate very little heat, and may have lifetimes of 50,000 hours or more. These relatively low power usage and maintenance requirements make LEDs good candidates for external lighting applications.

According to an aspect of the present invention, an outdoor lighting feature is presented. The outdoor lighting feature comprises a bollard, a solar panel disposed within a recess on the top of the bollard, a battery disposed within the bollard, the battery being electrically coupled to the solar panel and configured to receive and store energy from the solar panel and a light source disposed at least partially within the bollard and oriented to direct a light beam to a region external to the bollard, the light source being configured to draw an electric load from the battery.

The outdoor lighting feature may further comprise a bollard that is formed of a material selected from the group consisting of stone, concrete, brick, and masonry. In yet another embodiment of the present invention the bollard may comprise a decorative exterior.

The outdoor lighting feature may further comprise a light source that is comprised of at least one light-emitting diode, disposed at least partially within the bollard and oriented to direct a light beam to a region external to the bollard, the light source being configured to draw an electric load from the battery. In yet another embodiment, the outdoor lighting feature may further comprise a charge controller electrically coupled to the solar panel and the battery, the charge controller being configured to controllably charge the battery with the energy from the solar panel.

The outdoor lighting feature may comprise a system controller disposed within the bollard and electrically coupled to the battery and the light source, the system controller being configured to selectively activate and deactivate the light source. The system controller may also comprise a timing device and the timing device may comprise a capacitor.

In another embodiment of the outdoor lighting feature, the solar panel may be pivotally connected to the bollard and can be articulated between an open position in which the system controller and the battery can be accessed and a closed position in which the system controller and the battery are fully concealed within the bollard. The outdoor lighting feature may further comprise a motion sensor electrically coupled to the system controller, the motion sensor configured to provide to a signal to the system controller responsive to motion within a vicinity of the outdoor lighting feature.

The outdoor lighting feature may further comprise an inverter electrically coupled to the battery and the system controller, wherein the inverter is configured to receive a direct current from the battery and provide an alternating current to the system controller.

The outdoor lighting feature may further comprise a light level monitor configured to provide a signal to the system controller responsive to ambient light levels. The light level monitor is also configured to measure an output voltage of the solar panel. The outdoor lighting feature may further comprise a battery voltage monitor coupled to the battery and configured to provide a signal to the system controller responsive to a measurement of the voltage of the battery.

The outdoor lighting feature may further comprise a system controller disposed within the bollard and electrically coupled to the battery and the light source, the system controller being configured to selectively activate and deactivate the light source. The system controller may be a microcontroller configured to implement logic to selectively activate and deactivate the light source. In yet another embodiment, the microcontroller may be implemented as a state machine. In another embodiment, the outdoor lighting feature may comprise a light source disposed at least partially within the bollard and oriented to direct a light beam to a region external to the bollard, the light source being configured to draw an electric load from the battery. In yet another embodiment, the light source may be oriented substantially downward to direct the light beam onto a portion of ground adjacent the bollard. In yet another embodiment, the light source may be controllably set at one of a plurality of brightness levels.

The outdoor lighting feature may comprise a battery disposed within the bollard, the battery being electrically coupled to the solar panel and configured to receive and store energy from the solar panel. In yet another embodiment, the solar panel has an energy-collecting capacity and the battery has an energy-storing capacity such that the light source is capable of operating for a time period of at least 5 days where the battery does not store any energy during the time period. In yet another embodiment, the solar panel may have an energy-collecting capacity and the battery has an energy-storing capacity such that the light source is capable of operating at least at an intensity of a 40-watt lamp. In yet another embodiment, the battery may have an energy-storing capacity of at least 18 AMP hours.

According to one aspect of the present invention, a method is provided for controllably activating a solar-powered light source disposed within a decorative bollard. The method includes the acts of detecting a change in an ambient light level, starting a timer and placing a light source in a high-on state in response to the change in the ambient light level, comparing the timer to a plurality of predefined time durations, placing the light source in a low-on state upon the timer equaling a first predefined time duration of the plurality of predefined time durations, and placing the light source in an off state upon the timer equaling a second predefined time duration.

In another embodiment, a method for controllably activating a solar-powered light source disposed within a decorative bollard is provided. The method may further include the acts of detecting a voltage level of a battery, placing the light source in the off state in response to a voltage level of the battery being below a predefined threshold, and maintaining the light source in the off state in continued response to the voltage level of the battery being below the predefined threshold.

In another embodiment, a method for controllably activating a solar-powered light source disposed within a decorative bollard is provided. The method may further include the acts of detecting motion in a region while the light source is in one of the low-on state and the off state, starting a timer and placing the light source in the high-on state in response to motion in the region, and placing the light source in the off state upon the timer equaling a third predefined time duration.

In another embodiment, a method for controllably activating a solar-powered light source disposed within a decorative bollard is provided. The act of detecting motion in a region while the light source is in one of the low-on and the off state may further include the acts of detecting a second motion in the region while the light source is in the high-on state, and restarting the timer and maintaining the light source in the high-on state in response to the second motion in the region.

The method includes the acts of detecting a change in an ambient light level and detecting that the ambient light level has been below a predefined threshold for a third predefined time duration, starting a timer and placing a light source in a high-on state in response to the change in the ambient light level, comparing the timer to a plurality of predefined time durations, placing the light source in a low-on state upon the timer equaling a first predefined time duration of the plurality of predefined time durations, placing the light source in an off state upon the timer equaling a second predefined time duration of the plurality of predefined time durations.

Still other aspects, embodiments, and advantages of these exemplary aspects and embodiments, are discussed in detail below. Alternative designs and aesthetic features may be incorporated into the bollard. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a perspective view showing the front and side of a bollard incorporating solar panel and a light source according to one embodiment;

FIG. 2 represent a block diagram of the components of a control system for an outdoor light feature according to one embodiment;

FIG. 3 depicts a finite state diagram showing the behavior of the control system of the embodiment in FIG. 2;

FIG. 4a shows a front view of a bollard having decorative features according to an alternative embodiment;

FIG. 4b depicts a right-side view of the bollard of FIG. 4a;

FIG. 4c illustrates a rear view of the bollard of FIG. 4a;

FIG. 4d represents a left-side view of the bollard of FIG. 4a;

FIG. 4e shows a perspective view of the bollard of FIG. 4a;

FIG. 4f depicts a top view of the bollard of FIG. 4a;

FIG. 4g depicts a bottom view of the bollard of FIG. 4a;

FIG. 5a shows a front view of a bollard having decorative features according to an alternative embodiment;

FIG. 5b depicts a right-side view of the bollard of FIG. 5a;

FIG. 5c illustrates a rear view of the bollard of FIG. 5a;

FIG. 5d represents a left-side view of the bollard of FIG. 5a;

FIG. 5e shows a perspective view of the bollard of FIG. 5a;

FIG. 5f depicts a top view of the bollard of FIG. 5a;

FIG. 5g depicts a bottom view of the bollard of FIG. 5a;

FIG. 6a shows a front view of a bollard having decorative features according to an alternative embodiment;

FIG. 6b depicts a right-side view of the bollard of FIG. 6a;

FIG. 6c illustrates a rear view of the bollard of FIG. 6a;

FIG. 6d represents a left-side view of the bollard of FIG. 6a;

FIG. 6e shows a perspective view of the bollard of FIG. 6a;

FIG. 6f depicts a top view of the bollard of FIG. 6a;

FIG. 6g depicts a bottom view of the bollard of FIG. 6a;

FIG. 7a shows a front view of a bollard having decorative features according to an alternative embodiment;

FIG. 7b depicts a right-side view of the bollard of FIG. 7a;

FIG. 7c illustrates a rear view of the bollard of FIG. 7a;

FIG. 7d represents a left-side view of the bollard of FIG. 7a;

FIG. 7e shows a perspective view of the bollard of FIG. 7a;

FIG. 7f depicts a top view of the bollard of FIG. 7a; and

FIG. 7g depicts a bottom view of the bollard of FIG. 7a.

### DETAILED DESCRIPTION

At least one embodiment in accord with the present invention relates to a system and method for an outdoor lighting feature providing a bollard with an integrated solar panel, a battery and other components disposed within the bollard, and an LED light source for illuminating the terrain in the vicinity of the bollard.

The aspects disclosed herein, which are consistent with principles of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements, and features discussed in connection with any one or more embodiments are not intended to be excluded from a similar role in any other embodiments.

The systems described in any of the embodiments herein may also perform other functions. Moreover, the systems described herein may be configured to include or exclude any of the functions discussed herein. Thus, the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

System

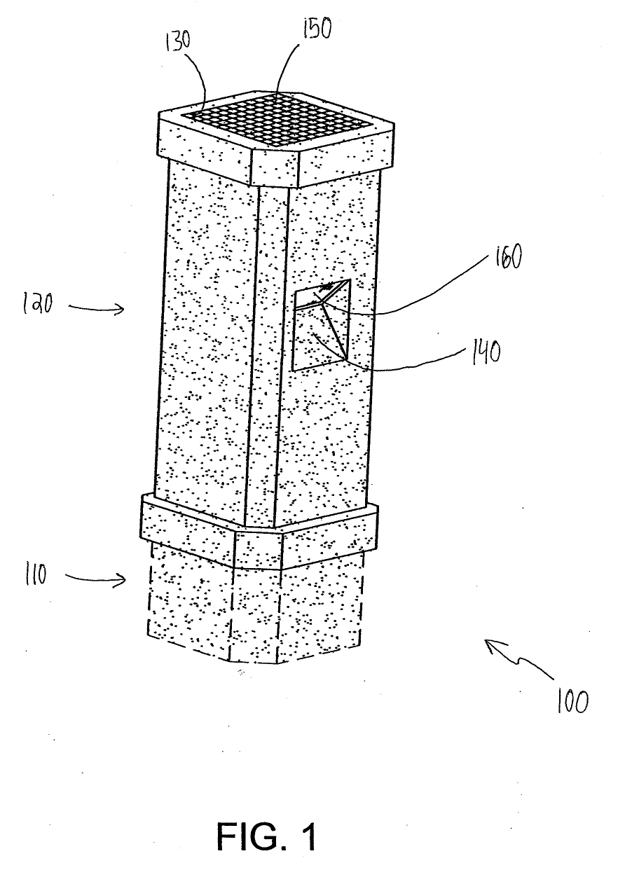

A system in accordance with several embodiments can be seen in FIG. 1. A bollard 100 is provided having a lower portion 110 and an upper portion 120. When the bollard is placed at a location where outdoor lighting is desired, the lower portion 110 is received in a recess in the ground. The upper portion 120 extends upwardly therefrom in a substantially vertical direction. The lower portion 110 may be simply placed into the recess and held in place by the surrounding soil. In situations where added stability is desired or necessary, for example, in locations where a significant portion of the soil is sand, concrete or other retaining material may be disposed around the lower portion 110 in order to retain the bollard 100 in the correct position and avoid the possibility of it toppling over. The lower portion 110 is represented in dashed lines to reflect the fact that it will be below ground level during use. The bollard may also be installed at grade level (not shown) on a concrete pad, by others. In one embodiment, the bollard may have rebar or similar anchoring projections extending below the base, preferably 10″ pieces of rebar extending 4″ below the base. In this case, the pad has to be drilled to receive the rebar or other anchor. It may then be epoxyed in place.

The bollard 100 may be formed of precast concrete, stone, masonry, synthetic or composite material, or other durable material. In some embodiments, both the lower portion 110 and the upper portion 120 may be formed of the same material, and the bollard 100 may be formed as a unitary structure. In other embodiments, the lower portion 110 may be of a different material than the upper portion 120. For example, it may be desirable that the upper portion 120 be formed of a decorative material such as metal, wood, or composite material. However, due to the effects of moisture, insects, and lateral underground forces resulting from settling and frost, in some embodiments it may be desirable that the lower portion 110 be formed of a durable, non-reactive, non-degradable material such as precast concrete, stone, or masonry.

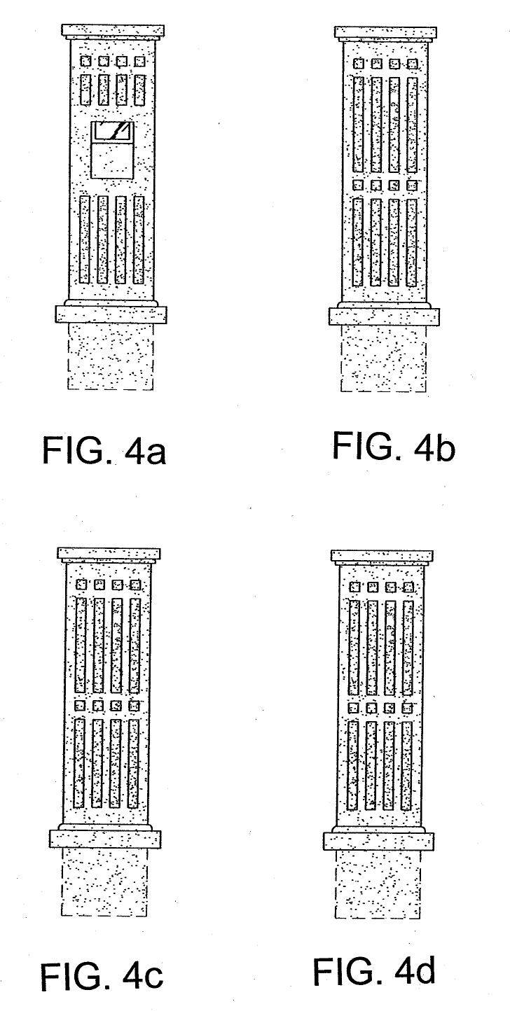

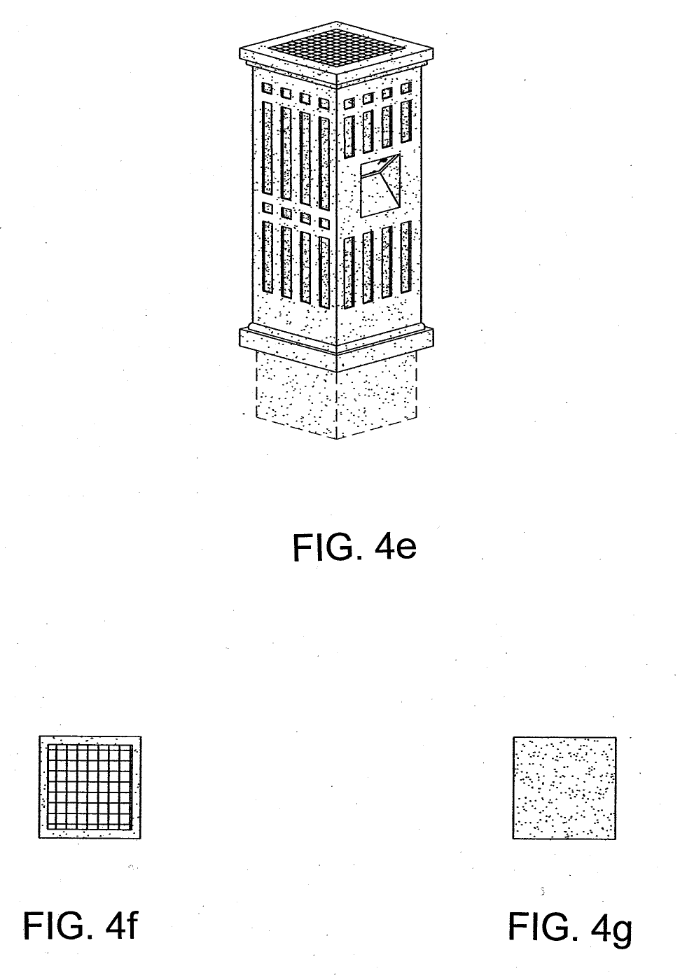

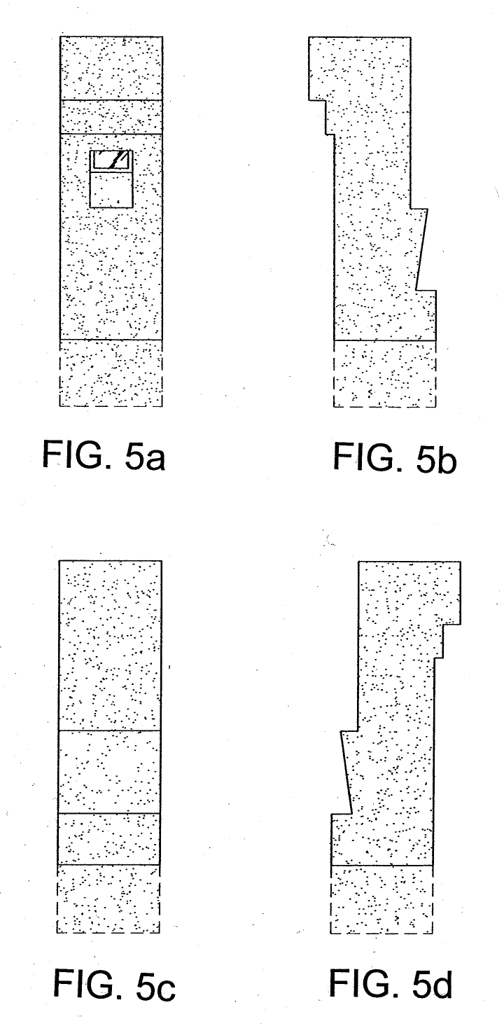

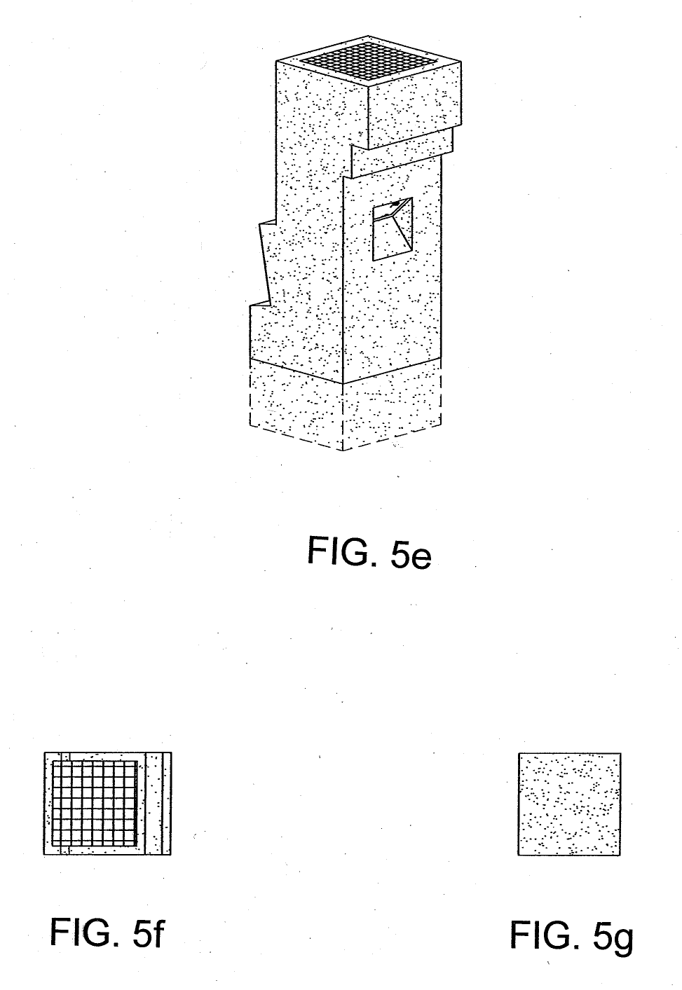

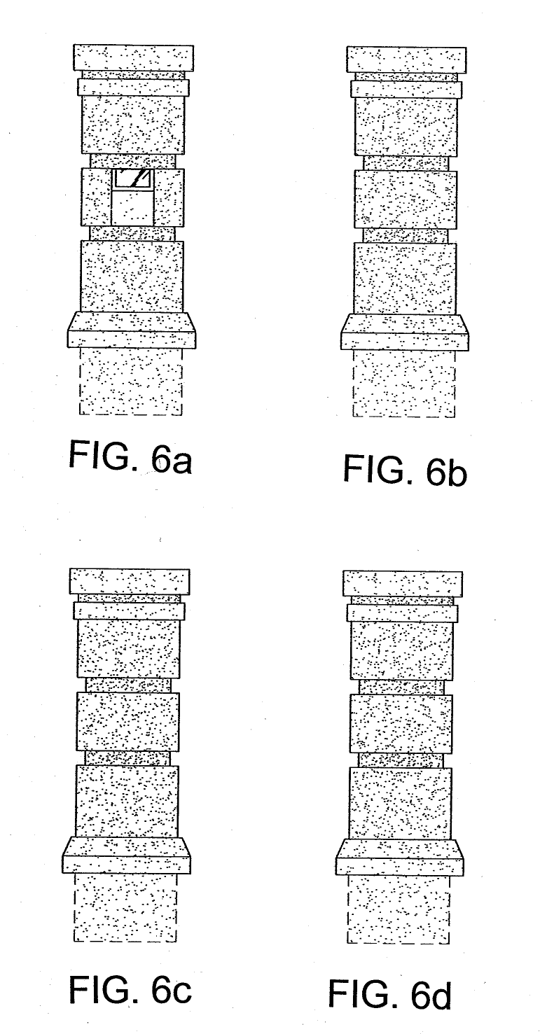

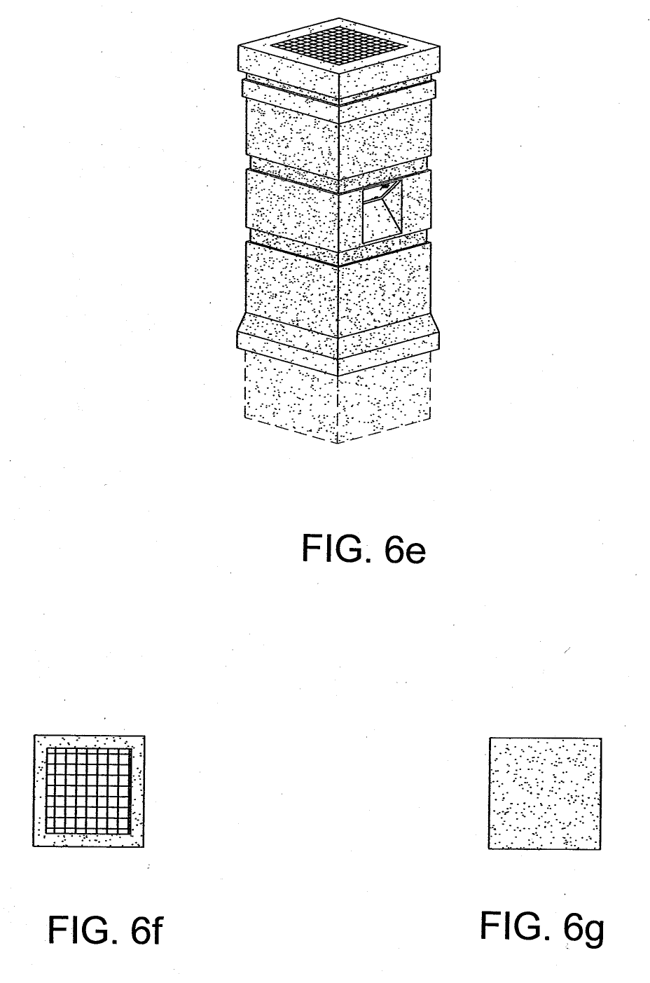

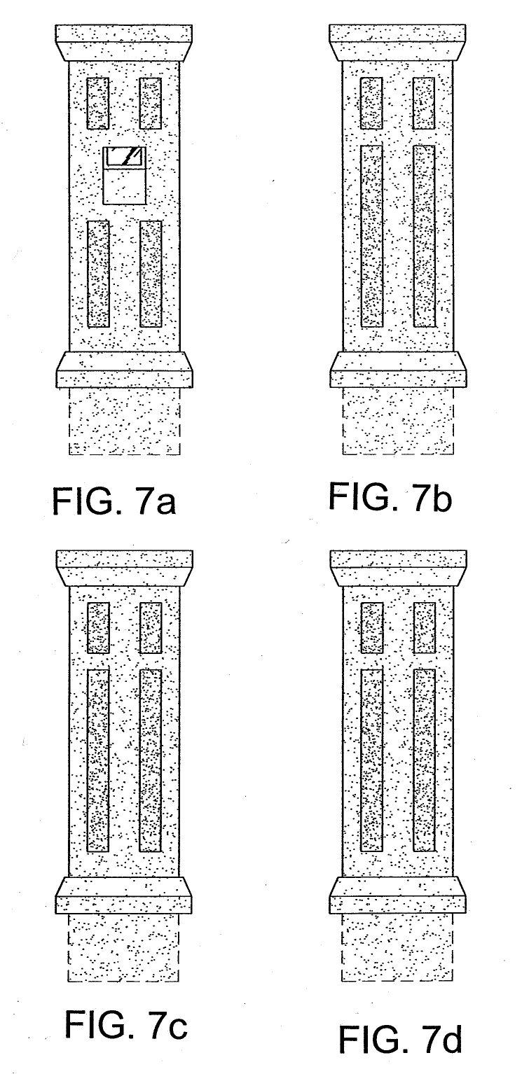

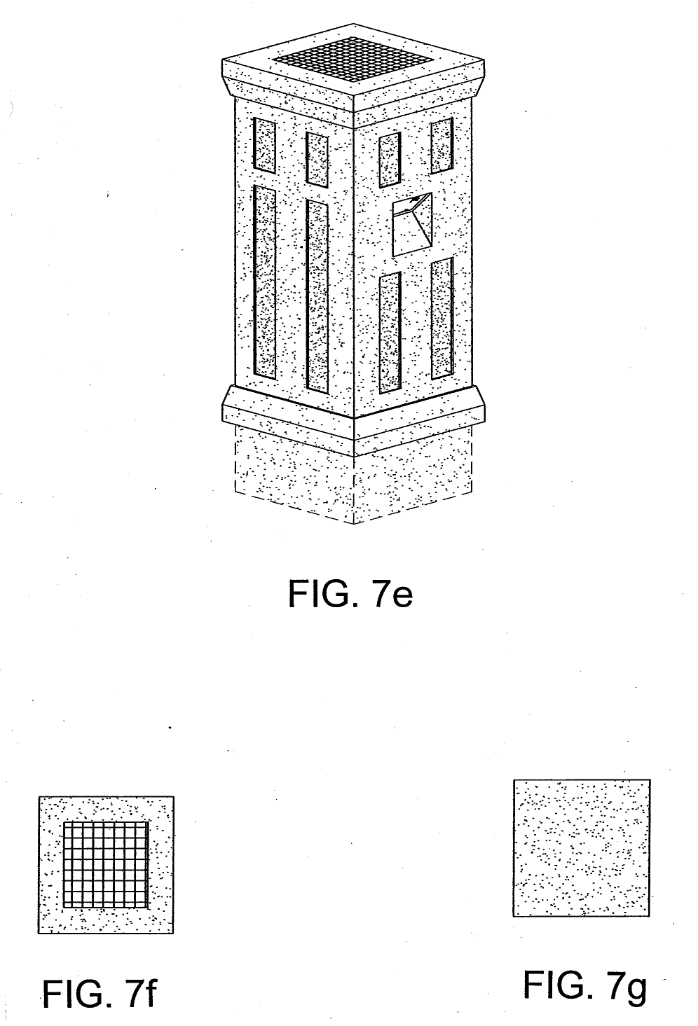

It will be appreciated that the several embodiments disclosed herein contemplate a range of dimensions, configurations, and aesthetic designs for the bollard 100, and that the bollard 100 seen in the present embodiments are shown for exemplary purposes only. In several embodiments, the bollard 100 may have a length and/or width of at least 8 inches. In several embodiments, the upper portion 120 of the bollard 100 may have a height of between 2 feet and 4 feet, though other dimensions are possible. The bollard 100 may incorporate any number of additional functional or non-functional features as are known in the art. FIGS. 4a-7g depict several alternative embodiments of the bollard 100 having a variety of decorative features. These embodiments are offered for exemplary purposes only, and it is contemplated that other aesthetic and decorative elements may be incorporated, either in addition to or instead of those features shown.

Referring again to FIG. 1, a solar panel 150 may be disposed within a first recess 130 on a top surface of the bollard 100. Solar panels are known in the art, and may be composed of a network of interconnected photovoltaic cells that convert solar energy into electricity. In the present embodiments, the electricity generated by the solar panel 150 is used to power a light source 160 without requiring a connection to a domestic power supply. The dimensions and configuration of the solar panel 150 may vary according to the power needs and solar exposure of the system. The solar panel 150 may have a surface area slightly smaller than the top surface of the bollard 100, that is, the solar panel 150 may cover a substantial portion of the top surface of the bollard 100. The top surface of the bollard 100 may have dimensions of roughly 12 inches by 12 inches, and the solar panel 150 may have dimensions of 10 inches by 10 inches. A variety of solar panels are commercially available, and the solar panel 150 may be chosen on the basis of its dimensions and/or output power. For example, a solar panel 150, such as a SolCharger™ solar module having a rated output power of between 3 W and 24 W, may be chosen and could be commercially available from SUNWIZE, Kingston, N.Y. In other embodiments, different commercially-available solar panels may be incorporated.

The solar panel 150 may sit in the first recess 130 and be retained in the first recess 130 only by the surrounding material of the bollard 130. In other embodiments, the solar panel 150 may be retained in the first recess 130 through the use of adhesives, screws, nails, or other fastening mechanism known in the art. In several embodiments, the solar panel 150 may also be pivotally retained within the first recess 130 through the use of a hinge or other pivot mechanism. This may allow the solar panel 150 to be articulated between an open position (not shown) in which the components of the system retained within the bollard 100 can be viewed and accessed and a closed position in which the components are fully concealed within the bollard 100. The bollard 100 or solar panel 150 may further provide a mechanism (not shown), such as a latch or strut, to retain the solar panel 150 in the open position to facilitate maintenance, inspection, or replacement of those components within the bollard 100. In some embodiments, the solar panel 150 may be provided with a handle or groove to facilitate articulation or to otherwise allow removal of the solar panel 150 from the first recess 130.

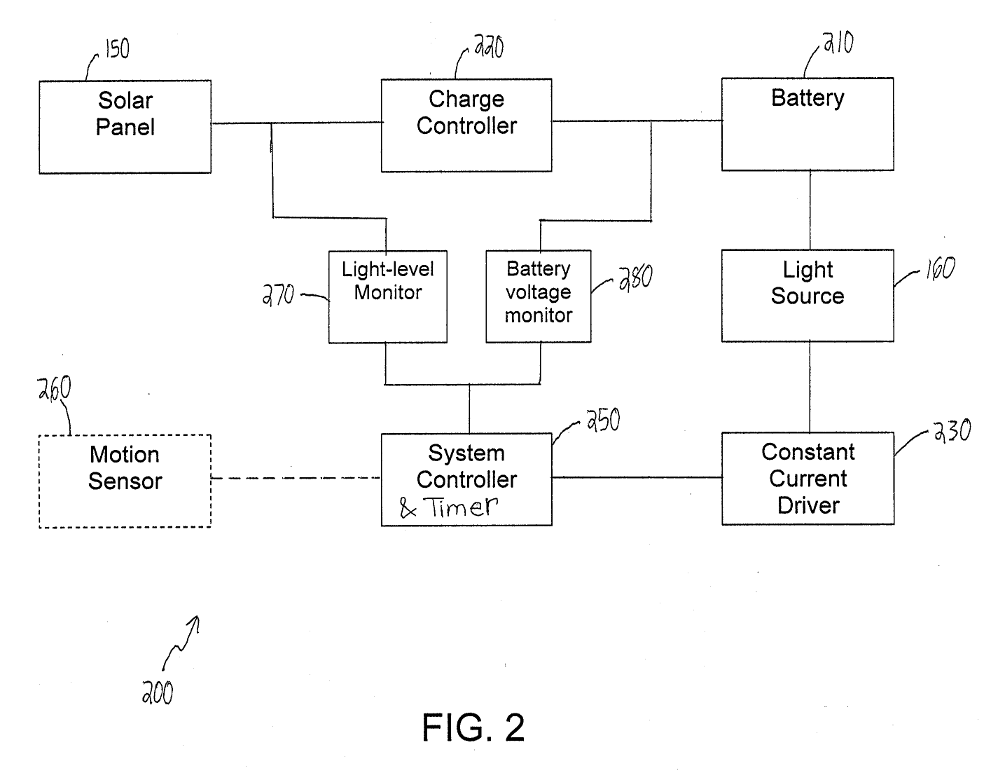

An electrical system of the outdoor lighting feature may be provided inside one or more cavities in the interior of the bollard 100. A block diagram showing the major components of an electrical system 200 according to one embodiment can be seen in FIG. 2. A battery 210 is provided that stores the electric charge generated by the solar panel 150. A charge controller 220 may be electrically coupled between the solar panel 150 and the battery 210 in order to prevent overcharging of the battery 210. The battery 210 powers the light source 160, which may be used to illuminate a walkway or other point or path on the ground. A constant current driver 230 may be provided to condition the power in a manner suitable for powering the light source 160. A system controller 250 may further be provided for switching the light source to an on state or an off state in response to certain external conditions and events detected by optional components such as a motion sensor 260, a light-level monitor 270, and a battery voltage monitor 280. One or more of the battery 210, the charge controller 220, the constant current driver 230, the system controller 250, the light-level monitor 270, and the battery voltage monitor 280 may be disposed within the bollard 100. The motion sensor 260 may be partially or entirely disposed within the bollard 100, or may be located external to the bollard 100.

The battery 210 is provided for receiving and storing the electric charge generated by the solar energy captured at the solar panel 150. The battery 210 is electrically coupled to the solar panel 150, and may be of any type known in the art, for example, a sealed-lead acid or gel cell battery. The battery 210 may incorporate components to protect against overcharge. The battery may be capable of retaining and delivering a direct current at a certain voltage level. In some embodiments, the battery 210 may be a 12 volt battery. For example, the battery 210 may be a 12V sealed lead-acid or gel cell battery commercially available from a number of sources, including GAMEWELL-FCI, Northford, Conn. Other battery types may be incorporated as well. In some embodiments, one or more cavities within the bollard 100 may be configured to receive a battery 210 with sufficient capacity to store enough voltage to power the light source 160 for up to several days. This may be desirable in situations where several consecutive days of inclement weather may be experienced, which may prevent the full charging of the battery 210 during those days.

In some embodiments, the constant current driver 230 may be electrically coupled between the battery 210 and the light source 160. The constant current driver 230 may be incorporated in embodiments where the light source 160 is an LED light. Constant current drivers are known in the art, and may be used to keep the brightness of the LED light constant regardless of fluctuations in the power supply or environmental conditions. In some embodiments, one or more of the system controller 250, the light source 160, the motion sensor 260, and the light-level monitor 270 may be configured to operate on direct current. In other embodiments, one or more of the components may be configured to operate on alternating current. In these embodiments, the constant current converter 230 may be provided to transform some or all of the output voltage of the battery 210 from direct current to alternating current so that those components can be appropriately powered. It will be appreciated that the constant current driver 230 is optional and is not present in all embodiments.

The light source 160 may be of any type of lighting known in the art, including but not limited to incandescent, fluorescent, or LED. The light source 160 may comprise one or more individual lighting components. In some embodiments, the light source 160 may comprise one or several LEDs. In these embodiments, the LEDs may be regular LEDs, miniature LEDs, or high power LEDs. The LEDs may be mounted to a plate or as part of a light engine. The plate or light engine may further be provided with heat-resistant or heat-absorbing material to absorb excess heat generated by the LEDs. For example, the LEDs may be provided on a LED light engine, available commercially from Sunovia Energy Technologies™, Sarasota, Fla.

The light source 160 may be selectively switched between two or more power or intensity states. In some embodiments, the light source 160 may feature a “high-on” state, in which the light source 160 is on at a relatively high intensity; a “low-on” state, in which the light source 160 is on but at an intensity somewhat lower than the high-on state; and a light off state, in which the light source 160 is unpowered or otherwise deactivated. In other embodiments, the light source 160 may only feature an on state and an off state; in these embodiments, no varying of the light intensity may be possible. The varying light intensity in a light source may be accomplished by varying the current output by the constant current driver 230. The varying light intensity may also be accomplished by selectively turning off any number of LEDs in the light source 160 if the light source 160 is composed of multiple LEDs. The intensity may also be varied through the control of the LED light engine. If the light source 160 is composed of only one LED the light off state can be accomplished by turning the single LED off.

In some embodiments, the light source 160 may be provided in a recess 140 on the exterior of the bollard 100. The recess 140 may be provided to shield the light source 160 from the elements, to direct the light emitted by the light source 160, or to protect the light source 160 from accidental shock or impact resulting from nearby activity. The recess 140 and the light source 160 may be configured to direct the light source 160 to the ground in the vicinity of the bollard 100. In some embodiments, the light source 160 may be angled downward at an acute angle from horizontal, for example, in the range of between 45 degrees and 70 degrees, in order to illuminate the ground. In other embodiments, the light emitted by the light source 160 may be directed to the ground through the use of a reflector (not shown), for example, a minor. In still other embodiments, no recess 140 may be provided, and the light source 160 may be provided on the exterior of the bollard 100. The recess 140 may be at such a height that the light source 160 casts an appropriate amount of light to a nearby area when the bollard 100 is in position. For example, the recess may be located approximately 2 feet above the bottom of the upper portion 120, thereby causing the light source to be approximately 2 feet above the ground during operation.

In several embodiments, the charge controller 220 may be electrically coupled between the solar panel 150 and the battery 210 to prevent the battery 210 from being overcharged during periods of high energy output of the solar panel 150, for example, during times of intense, direct sunlight. Charge controllers are known in the art, and may include components that limit the rate at which voltage is transferred to the battery 210, as well as components that may prevent further charging of the battery 210 once it has reached a certain charge level. In some embodiments, the charge controller 220 may be a SunGuard™ Solar Controller, commercially available from the Morningstar Corporation, Washington Cross, Pa. In other embodiments, other custom or commercially-available charge controllers may be utilized. It will be appreciated that the constant current driver 230 is optional and is not present in all embodiments.

In some embodiments, the system controller 250 may be provided. The system controller 250 is capable of switching the light source 160 between several states, for example, on, high-on, low-on, and off, in response to one or more external conditions, events, or timing schemes. For example, in some embodiments the system controller 250 may incorporate a timing device that tracks an elapsed amount of time. After a certain amount of time has elapsed, the system controller 250 may determine that the light source 240 should be switched to a different state. The system controller 250 may then switch the light source 240 to a different state, for example, from low-on to light off. The functionality of the timing device may be achieved through a variety of mechanisms. In some embodiments, a capacitor (not shown) may be incorporated into an electric timing circuit. In other embodiments, a digital timer or other timing mechanism may be incorporated. In several embodiments, multiple timing devices are incorporated, allowing for several independent measures of lapsed time. It will be appreciated that the system controller 250 is optional and is not present in all embodiments.

In several embodiments, the system controller 250 is implemented as a microcontroller. The microcontroller may be a single integrated circuit, and may include a processor, as well as a read/write memory or other data structure for storing the state of the system. In some embodiments, the microcontroller may form a finite state machine (FSM) through the use of a programmable logic device, a programmable logic controller, logic gates, flip flops, relays, or other methods or structures known in the art. The FSM may include one or more registers to store state variables, as well as one or more logic components to calculate states. The microcontroller may further be provided with one or more interfaces through which to receive signals from one or more of the motion sensor 260, the light-level monitor 270, and the battery-voltage monitor 280. The one or more interfaces may be an electrical wire configured to receive an input, or may be any other serial or parallel interface or standard known in the art, for example, Firewire, USB, IDE, SCSI, PCI, Infiniband. In some embodiments, the system controller 250 may be sized to fit in a polycase enclosure, and may be potted for protection against moisture.

In several embodiments, the light-level monitor 270 is provided. The light-level monitor 270 may send a signal to the system controller 250 indicating that the ambient light in the external environment around the bollard 100 is at a level above or below a particular preset threshold. In some embodiments, the light-level monitor 270 may be electrically coupled to the solar panel 150 and configured to monitor the output voltage level of the solar panel 150. In these embodiments, the light-level monitor 270 may send a low-light signal to the system controller 250 when the output voltage of the solar panel 150 has dropped below a preset threshold. This drop in the output voltage indicates that the solar panel 150 is not being reached by a substantial amount of sunlight, which may indicate that dusk, nighttime, or other low-light situation has occurred. The system controller 250 may switch the light source 240 to a different state in response to the low-light signal. It will be appreciated that the light-level monitor 270 is optional and is not present in all embodiments.

In several embodiments, the light-level monitor 270 may send signals to the system controller 250 on a regular periodic basis, for example, every 15 minutes. In some embodiments, the system controller 250 may store the most recent signal as well as one or more past signals, or may otherwise store some record of the recent ambient light level. In these embodiments, the system controller 250 may take some action based on the current state and/or the past state of the light-level monitor 270. For example, the system controller 250 may switch the light source 240 to an on state once a low light level has been indicated for two consecutive readings. In the embodiment where the light-level monitor 270 sends signals every 15 minutes, this configuration would result in the system controller 250 switching the light source 240 to an on state when there has been low light for the past 15 minutes. Such a configuration would prevent the undesirable situation where the light source 240 is switched to an on state whenever a shadow or other temporary condition caused the light-level monitor 270 to signal a low ambient light level.

In several embodiments, the battery voltage monitor 280 may be provided. The battery voltage monitor 280 may detect, track, or calculate the voltage level of the battery 210 on a continuous or periodic basis. The battery voltage monitor 280 may then send a low-battery signal to the system controller 250 when the stored voltage of the battery 210 has dropped below a preset threshold. The system controller 250 may switch the light source 240 to a different state in response to the low-battery signal. For example, the system controller 250 may be configured to switch the light source 240 to a light off state when the voltage of the battery 210 has dropped below a certain level in order to avoid fully exhausting the battery 210. It will be appreciated that the battery voltage monitor 280 is optional and is not present in all embodiments.

In several embodiments, the motion sensor 260 is provided. The motion sensor 260 is configured to send a motion signal to the system controller 250 in response to movement detected within the field of view of the motion sensor 260. The system controller 250 may then switch the light source 240 to a different state. For example, the system controller 250 may switch the light source 250 from either an off state or low-on state to a high-on state in response to movement. This may be desirable for security purposes, or to provide selective illumination only when there are persons or activity in the area.

The motion sensor 260 may be an active infrared sensor, a passive infrared (PR) sensor, an ultransonic sensor, a microwave sensor, or other motion-sensing technology as is known in the art. In some embodiments, the motion sensor 260 is a PIR sensor that measures infrared light radiating from objects within its field of view. Such PIR sensors are known in the art. In some embodiments, the motion sensor 260 may be configured to send the motion signal to the system controller 250 only if the motion detected is above a certain threshold. This selective signaling prevents the undesirable situation where the light source 240 is switched to an on state in response to an animal, insect, precipitation, or wind-blown leaves, trees, debris, or other environmental factors that do not warrant switching the light source 240 to an on state. It will be appreciated that the motion sensor 260 is optional and is not present in all embodiments, and the motion sensor 260 is depicted with dashed lines to represent its optional nature.

The components described herein may be electrically coupled by wires or in any other manner known in the art. In situations where increased reliability is needed, or where environmental concerns such as moisture are a concern, the wires may incorporate additional shielding or provide other protection. The components may be electrically grounded, and the system 200 and/or the components may be provided with a circuit breaker, fuses, or other mechanism for preventing damage caused by overload or short circuit.

Exemplary Method

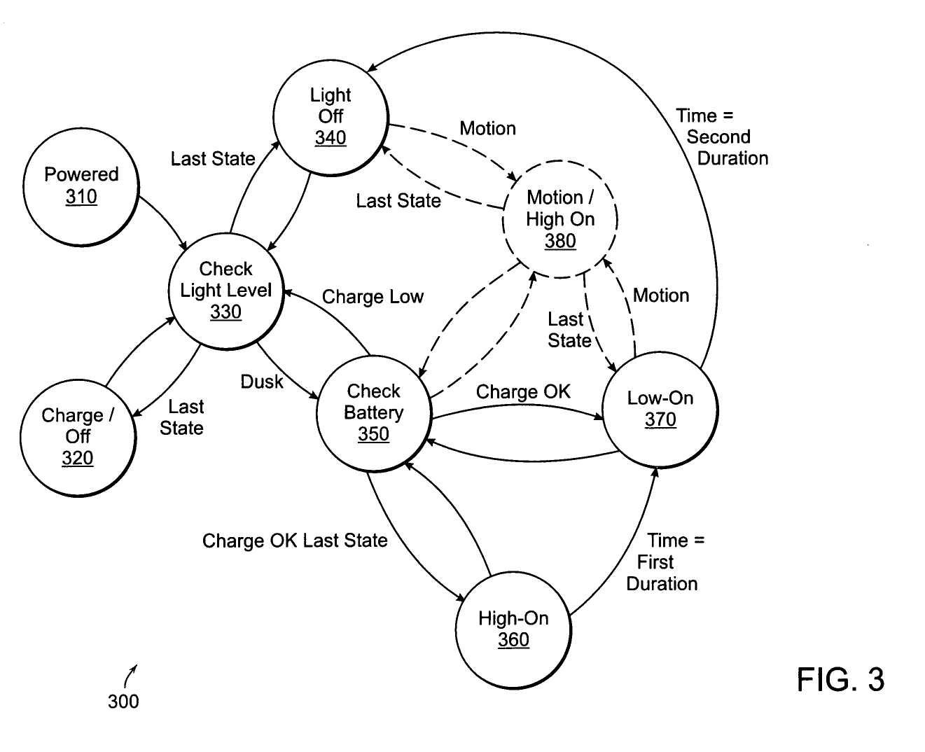

Having described various aspects of an outdoor light feature system, the operation of such a system 200 is now described. A method 300 according to one embodiment of the invention is described with reference to the finite state diagram seen in FIG. 3.

The system 200 may be controllably switched to a powered state 310. In the powered state 310, the system 200 may carry out one or more of the acts described herein, and the light source 240 may be switched between multiple states. At other times during the powered state 310, the system 200 may not be functional but one or more components may be in a standby mode, and may draw phantom power from the battery. In an unpowered state (not shown), the light source 240 remains in an off state and none of the components may be drawing power.

During daylight hours or other situations in which the light sensor 260 detects an ambient light level above a certain threshold, the system 200 is in a charge/off state 320 and a light off state 340. In the light off state 340 the light source 240 is turned off. In the charge/off state 320, solar energy collected at the solar panel 150 may be stored in the battery 210. In some embodiments, the charge controller 220 may monitor the voltage of the battery 210 and cause the battery 210 to move to the charge/off state 320 and stop being charged when it has stored a certain amount of charge, or when the rate at which it is being charged is above a certain level.

While in the charge/off state 320 and the light off state 340, the system 200 may move to the check light level state 330, periodically and for a continuous duration, to check the ambient light level in the manner described above. For example, the system controller 250 may monitor the light level for a period of at least 15 minutes. If the light level remains low for that period of time it is likely that the light level monitor is indicating dusk. Other periods of time could be selected that accurately detect a change in light level and minimize use of the system. If the light level is above the preset threshold, indicating that there is still sunlight reaching the solar panel 150, then the system 200 moves back to the prior state, that is, the charge/off state 320 and the light off state 340.

In some embodiments, if the light level is below the preset threshold, likely indicating dusk or nighttime, then the system 200 may move to the check battery state 350. If the battery voltage monitor 280 has indicated to the system controller 250 that the battery 210 has stored a sufficient charge, then the system controller 250 starts a timer and the system 200 moves to a high-on state 360. If the battery voltage monitor 280 has indicated to the system controller 250 that the battery 210 has stored an insufficient charge the system will return to the check light level state 330 and will not move on to the high-on state 360. A sufficient battery level is at least approximately 0.5 Amps per hour and below about 0.5 Amps per hour is insufficient.

In other embodiments, the system controller 250 may store the most recent signal from the light-level monitor 270, as well as one or more past signals, or may otherwise store some record of the recent ambient light level. In these embodiments, the system 200 may only move to the high-on state 360 once a low light level has been indicated for two consecutive readings. In the embodiment where the light-level monitor 270 sends signals periodically for a 15 minute duration, this configuration would result in the system 200 moving to the previous state, that is, the charge/off state 320 and the light off state 340 when there has been a high ambient light level for the past 15 minutes.

While in the high-on state 360, the system controller 250 may move to the check battery state 350, periodically and for a continuous duration, to check the voltage level of the battery in the manner described above. If the voltage level is sufficient, then the system 200 remains in the high-on state 360. If the voltage level is insufficient, then in some embodiments the system 200 may move to the charge/off state 320 and the light off state 340. In other embodiments, the system 200 may move to a low-on state 370 in order to conserve power. In still other embodiments, the system 200 may remain in the high-on state 360 until the battery 210 is exhausted.

In one embodiment, the system may be configured to move from the high-on state 360 to the low-on state 370 to the light off state 340 after the expiration of preprogrammed time duration. The system could be programmed for any number of durations, however for the sake of example only three durations are discussed. In order to determine whether time duration has expired, the system controller 250 may compare the timer to the preprogrammed duration. After a first duration has expired, the system moves from the high-on state 360 to the low-on state 370. This may be desirable where it is expected that activity in the area of the bollard 100 will diminish a few hours after nightfall, or where light pollution is a concern. The first duration may be a predefined amount of time, for example, 3 hours. Other time durations based on the environment or need could be used. In some embodiments, the first duration is preset and cannot be changed. In other embodiments, the first duration may be configurable.

While in the low-on state 370, the timer continues to run. The system controller 250 may move to the check battery state 350 on a continuous or periodic basis to check the voltage level of the battery in the manner described above. If the voltage level is sufficient, then the system 200 remains in the low-on state 370. If the voltage level is insufficient, then in some embodiments the system 200 may move to the light off state 340. In other embodiments, the system 200 may remain in the low-on state 360 until the battery 210 is exhausted.

After a second duration has expired as measured by the timer in the system controller 250, the system moves from the low-on state 370 to the light off state 340. The second duration may be a predefined amount of time, for example, 6 hours. Other time durations based on the environment or need could be used. In some embodiments, the second duration is preset and cannot be changed. In other embodiments, the second duration may be configurable.

In embodiments incorporating the motion sensor 260, while the system 200 is in the low-on state 370 or the light off state 340, the system controller 250 may be configured to receive a motion signal from the motion sensor 260 in response to movement detected within the field of view of the motion sensor 260. In the event that the system controller 250 receives a motion signal, the system 200 may move to the check battery state 350 to check the voltage level of the battery 210 in the manner described above. If the voltage level is insufficient, then the system 200 remains in the low-on state 370 or the light off state 340. If the voltage level is sufficient, then the system 200 may immediately move to a motion/high-on state 380, in which the light source 240 is switched to a high-on state 380 and a timer is started by the system controller 250 to time for a third duration. In some embodiments, after a third duration has expired as measured by the timer in the system controller 250, the system 200 moves to the previous state, that is, the low-on state 370 or the light off state 340.

In other embodiments, the system controller 250 may be configured to receive a second motion signal from the motion sensor 260 in response to movement detected while the system 200 is already in the motion/high-on state 380. In some of these embodiments, the system controller 250 may reset the timer when the second motion signal is detected. Therefore, in these embodiments the system 200 in effect stays in the motion/high-on state 380 until a length of time equal to the third duration has passed without any motion being detected by the motion sensor 260. After the third duration has expired, the system 200 returns to the previous state, that is, the low-on state 370 or the light off state 340.

The third duration may be a predefined amount of time and may be somewhat shorter than the first duration and the second duration. For example, in some embodiments, the third duration may be 5 minutes. Other third duration time intervals may be desirable. In some embodiments, the third duration is preset and cannot be changed. In other embodiments, the third duration may be configurable.

It will be appreciated that the motion sensor 260 and the motion/high-on state 380 are optional and do not appear in all embodiments. Therefore, the motion/high-on state 380 and all transitions to and from it are represented in dashed lines in FIG. 3 to reflect this optional nature.

While in the motion/high-on state 380, the system controller 250 may move to the check battery state 350 on a continuous or periodic basis to check the voltage level of the battery in the manner described above. If the voltage level is sufficient, then the system 200 remains in the motion/high-on state 380. If the voltage level is insufficient, then in some embodiments the system 200 may move to the light off state 340. In other embodiments, the system 200 may remain in the motion/high-on state 380 until the expiration of the third duration or the battery 210 is exhausted.

After the cycle is completed and the battery 210 is exhausted the system 200 may return to the original state, that is, the charge/off state 320 and the light off state 340. The cycle may then repeat starting with the check light level state 330.

The movement between particular states in FIG. 3 depicts one particular sequence of acts in a particular embodiment. The acts included in each of these processes may be performed by, or using, one or more of the components as discussed herein. Some acts are optional and, as such, may be omitted in accord with one or more embodiments. Additionally, the order of acts can be altered, or other acts can be added, without departing from the scope of the present invention.

Any reference to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim elements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. An outdoor lighting feature comprising:
a bollard;
a solar panel disposed on the top of the bollard;
a battery disposed within the bollard, the battery being electrically coupled to the solar panel and configured to receive and store energy from the solar panel; and
a light source disposed at least partially within the bollard and oriented to direct a light beam to a region external to the bollard, the light source being configured to draw an electric load from the battery.

2. The outdoor lighting feature of claim 1, wherein the bollard is formed of a material selected from the group consisting of stone, concrete, brick, and masonry.

3. The outdoor lighting feature of claim 2, wherein the bollard comprises a decorative exterior.

4. The outdoor lighting feature of claim 1, wherein the light source comprises at least one light emitting diode.

5. The outdoor lighting feature of claim 1, further comprising a charge controller electrically coupled to the solar panel and the battery, the charge controller being configured to controllably charge the battery with the energy from the solar panel.

6. The outdoor lighting feature of claim 1, further comprising a system controller disposed within the bollard and electrically coupled to the battery and the light source, the system controller being configured to selectively activate and deactivate the light source.

7. The outdoor lighting feature of claim 6, wherein the system controller comprises a timing device.

8. The outdoor lighting feature of claim 7, wherein the timing device comprises a capacitor.

9. The outdoor lighting feature of claim 6, wherein the solar panel is pivotally connected to the bollard and can be articulated between an open position in which the system controller and the battery can be accessed and a closed position in which the system controller and the battery are fully concealed within the bollard.

10. The outdoor lighting feature of claim 6, further comprising a motion sensor electrically coupled to the system controller, the motion sensor configured provide a signal to the system controller responsive to motion within a vicinity of the outdoor lighting feature.

11. The outdoor lighting feature of claim 6, further comprising an inverter electrically coupled to the battery and the system controller, wherein the inverter is configured to receive a direct current from the battery and provide an alternating current to the system controller.

12. The outdoor lighting feature of claim 6, further comprising a light level monitor configured to provide a signal to the system controller responsive to ambient light levels.

13. The outdoor lighting feature of claim 12, wherein the light level monitor is configured to measure an output voltage of the solar panel.

14. The outdoor lighting feature of claim 6, further comprising a battery voltage monitor coupled to the battery and configured to provide a signal to the system controller responsive to a measurement of the voltage of the battery.

15. The outdoor lighting feature of claim 6, wherein the system controller further comprises a microcontroller configured to implement logic to selectively activate and deactivate the light source.

16. The outdoor lighting feature of claim 15, wherein the microcontroller is implemented as a state machine.

17. The outdoor lighting feature of claim 1, wherein the light source is oriented substantially downward to direct the light beam onto a surface adjacent the bollard.

18. The outdoor lighting feature of claim 1, wherein the light source can be controllably set at one of a plurality of brightness levels.

19. The outdoor lighting feature of claim 1, wherein the solar panel has an energy-collecting capacity and the battery has an energy-storing capacity such that the light source is capable of operating for a time period of at least about 5 days where the battery does not store any energy during the time period.

20. The outdoor lighting feature of claim 1, wherein the solar panel has an energy-collecting capacity and the battery has an energy-storing capacity such that the light source is capable of operating at an intensity of at least about a 40-watt lamp.

21. The outdoor lighting feature of claim 1, wherein the battery has an energy-storing capacity of at least about 18 Amp hours.

22. A method for controllably activating a solar-powered light source disposed within a decorative bollard, comprising acts of:
detecting a change in an ambient light level;
starting a timer and placing a light source in a high-on state in response to the change in the ambient light level;
comparing the timer to a plurality of predefined time durations;
placing the light source in a low-on state upon the timer equaling a first predefined time duration of the plurality of predefined time durations;
placing the light source in an off state upon the timer equaling a second predefined time duration of the plurality of predefined time durations.

23. The method of claim 22, further comprising the acts of:
detecting a voltage level of a battery;
placing the light source in the off state in response to a voltage level of the battery being below a predefined threshold; and
maintaining the light source in the off state in continued response to the voltage level of the battery being below the predefined threshold.

24. The method of claim 22, further comprising the acts of:
detecting motion in a region while the light source is in one of the low-on state and the off state;
starting a timer and placing the light source in the high-on state in response to motion in the region; and
placing the light source in the off state upon the timer equaling a third predefined time duration of the plurality of predefined time durations.

25. The method of claim 24, wherein the act of detecting motion in a region while the light source is in one of the low-on and the off state detects a first motion, further comprising:
detecting a second motion in the region while the light source is in the high-on state; and
restarting the timer and maintaining the light source in the high-on state in response to the second motion in the region.

26. The method of claim 22, wherein the act of detecting a change in an ambient light level further comprises detecting that the ambient light level has been below a predefined threshold for a third predefined time duration of the plurality of predefined time durations.
